(19) United States
(12) Patent Application Publication
(10) Pub. No.: US 2007/0219996 A1
(43) Pub. Date: Sep. 20, 2007

(54) System and method for creating custom playlists based on user inputs

(75) Inventor: Justin Jarvinen, Chicago, IL (US)

Correspondence Address: FOLEY & LARDNER LLP, 321 NORTH CLARK STREET, SUITE 2800, CHICAGO, IL, 60610-4764, US

(73) Assignee: VerveLife

(21) Appl. No.: 11/724,379

(22) Filed: Mar. 15, 2007

Related U.S. Application Data
(60) Provisional application No. 60/783,435, filed on Mar. 17, 2006.

(51) Int. Cl. G06F 17/30

(52) U.S. Cl. 707/7

(57) ABSTRACT

A system and method for creating custom playlists based on user inputs. The present invention allows individual users to build custom music playlists based upon their own inputs. The “lifestyle” playlist building tool of the present invention receives specific information about the user through a question and answer interface. The building tool automatically delivers a playlist of a specified number of individual media items (a playlist), each of which matches the user's inputs.

### CROSS REFERENCE TO RELATED APPLICATION

This application claims priority to U.S. Provisional Patent Application No. 60/783,435 filed Mar. 17, 2006, herein incorporated by reference in its entirety.

### FIELD OF THE INVENTION

The present invention relates generally to the creation of custom playlists. More particularly, the present invention relates to the creation of custom music playlists based on a set of user inputs.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, the downloading of music content over the Internet has exploded in popularity. Although a large percentage of music downloading occurs through pay systems such as iTunes®, individuals download music through other environments as well. An example of such an environment is through the website of a particular company. A number of companies offer a limited number of songs and other content through their own websites for promotional purposes.

Although companies may obtain an increased amount of traffic on their websites through the offering of songs, this activity often provides little or no information about their own customer base. In some instances, although a company may be able to obtain some basic information from users who download songs (e.g., email address, age, etc.), this type of information often tells the company little about who its customers really are. Although this could theoretically be remedied by asking users to fill out a survey before downloading, this can be aggravating or annoying for the user and could result in less interest in the site.

In addition to the above, many company websites that offer music often include only a limited library of music files. As a result, a person visiting the site will have differing reactions to the provided music; some may enjoy all of the selections, while others do not like any of them. Although a company can try to appeal to all tastes by providing a larger library of songs, users may not be interested in browsing through possibly hundreds of songs to find only one or two that are to his or her own liking.

There is therefore a need for a system that caters to a user's personal music tastes while also providing companies or sponsors with the ability to easily obtain valuable information about their users or consumers.

### SUMMARY OF THE INVENTION

The present invention comprises a system and method by which users can create personalized digital music playlists based upon specific inputs. These inputs include personality-related characteristics of a user. Such characteristics may include, but are not limited to, activities of interest to a user, life events, moods, tendencies, likes and dislikes, product preferences, and other characteristics. Other inputs besides personality-related characteristics, such as dates (e.g., birthdate, etc.) and locations (e.g., place of residence) of significance to the user, may also be used. Through a graphical user interface (GUI), users answer a set of questions. Each answer directly correlates to an “attribute” in a song. Each song stored in a database is categorized by “attributes,” a list of unique identifiers or characteristics that have been previously identified by database administrators. Based upon the user's answers to the questions, a playlist of songs is generated, where the attributes of the songs generally correspond to the user's answers.

With the present invention, playlists can be tailored specifically to the personality-related characteristics of individual users. As a result, users are more likely to obtain an increased level of enjoyment out of their own playlist.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a diagram showing the process by which a customized user playlist is generated according to one embodiment of the present invention;

FIG. 2 is a screen shot showing a first question being presented to a user, with the first question being used to identify a genre of music which would be preferable to a user;

FIG. 3 is a screen shot showing a second question being presented to a user, with the second question being used to identify a personality trait of the user;

FIG. 4 is a screen shot showing a third question being presented to a user, with the third question being used to identify a current mood of the user;

FIG. 5 is a screen shot representative of the period in which a media library is being scanned for media that correlate to the answers to the questions presented in FIGS. 2-4;

FIG. 6 is a screen shot showing a set of media items being presented to the user, the media items having been selected based upon the answers to the questions presented in FIGS. 2-4;

FIG. 7 is a screen shot showing the final custom playlist being presented to the user, after individual media items from the list in FIG. 6 have been selected by the user; and

FIG. 8 is a diagram showing how individual media items can be matched with the user's answers to the questions provided in FIGS. 2-4.

### DETAILED DESCRIPTION OF THE PREFERRED EMBODIMENTS

The present invention comprises a system and method by which users can create personalized digital music playlists based upon specific inputs. These inputs include personality-related characteristics of a user. Such characteristics may include, but are not limited to, activities of interest to a user, life events, moods, tendencies, likes and dislikes, product preferences, and other characteristics. Other inputs besides personality-related characteristics, such as dates and locations of significances to the user, may also be used. Through a graphical user interface (GUI), users answer a set of questions, in multiple choice form according to one embodiment of the invention. Each answer directly correlates to an “attribute” in a song. Each song stored in a database is categorized by “attributes,” a list of unique identifiers or characteristics that have been previously identified by database administrators. For example, when asked what type of bar or pub a user might prefer, the answer “country bar” may correlate to country music, whereas “lounge” may correlate to a down-tempo ambient. Similarly, when asked about tattoos, an answer of “large snake tattoo” will deliver different music than a “no-tattoo” preference. Further, if there is a question regarding preferred road-trip, an answer “from Chicago to Detroit” might deliver a “road-trip” playlist comprised of music from Kid Rock and Bob Seger, both of whom are from the Detroit area, while answers identifying other cities might correlate to artists from those areas. Still further, a user could be asked who his or her favorite actor/actress, athlete, or other celebrity is, where the user's answer correlates to songs or other media content that the selected individual has pre-selected or for which the selected individual has indicated an affinity or preference. Alternatively, a database administrator may have previously linked particular songs or other media content with a particular actor/actress, athlete, or other celebrity. These songs or other media content may, in turn, correlate with particular user answers.

In another embodiment of the invention, some or all of the “questions” do not even have to be text-based. For example, pieces of artwork of different styles could be displayed to the user, with the user selecting the item which most appeals to him or her. Other forms of media, such as photographs, movie clips, television clips, and animations, could also be presented to the user as mechanisms by which to obtain input about the user's personality-related characteristics.

Based upon the user's answers to the questions, a playlist of songs is generated, where the attributes of the songs generally correspond to the user's answers.

With the present invention, playlists can be tailored specifically to the personality-related characteristics of individual users. As a result, users are more likely to obtain an increased level of enjoyment out of their own playlists.

The system of the present invention can be made available to consumers and other users through websites owned or operated by or for various providers of goods and services, allowing providers to offer a unique and highly valuable experience to their respective consumer bases. In this environment, the provider receives valuable information in the data it obtains in exchange for the user experience. In a preferred embodiment of the invention, the system tracks all user inputs and reports them back to an administrator via an administrative portal. With this information, a provider can determine the likes, dislikes, activity preferences, personalities, and other information about their consumers by engaging them in this unique dialogue, where the user receives music in return. This music can either be provided to the user free of charge, or a nominal fee can be charged.

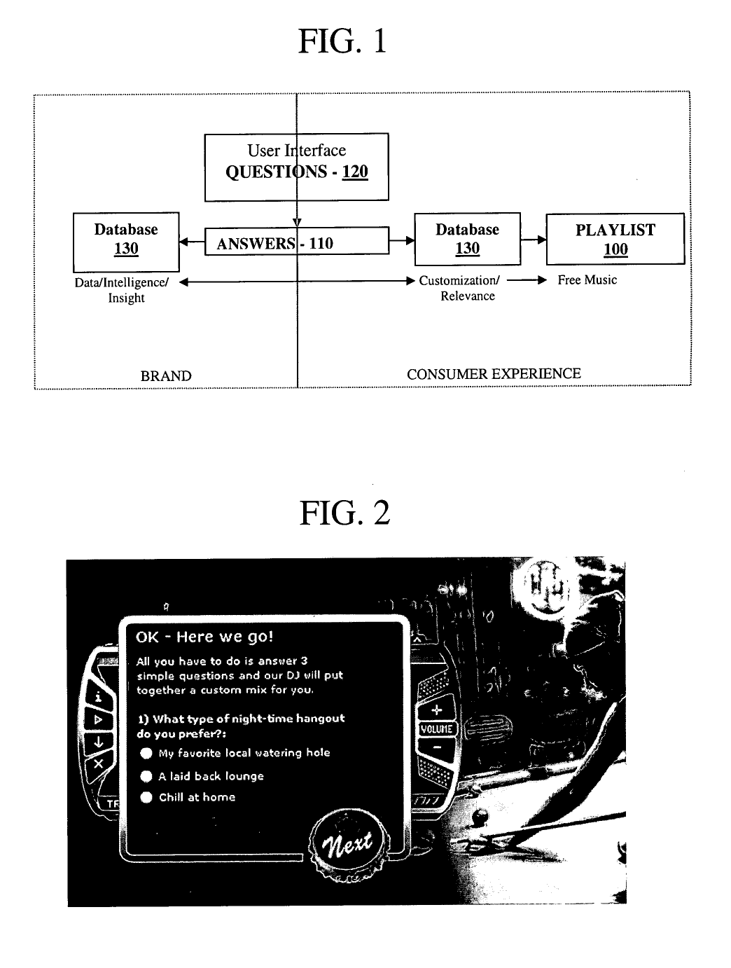

FIG. 1 is a diagram showing the process by which a customized user playlist is generated according to one embodiment of the present invention. As shown in FIG. 1, a playlist 100 is generated based upon answers 110 that are provided in response to a plurality of user interface questions 120. In a preferred embodiment of the invention, the user interface questions 120 are presented in multiple choice form. The answers 110 are provided to a database 130, which creates the customized playlist 100 based upon the attributes identified with the media items contained therein. The term “media” item can refer to virtually any type of media, including audio such as sound tracks, video, images, text-based content, or any combination thereof. The media items are selected from a plurality of candidate playlist media items (i.e., the available media items) in the database. The entire process of the present invention can be implemented through the use of computer code stored on memory units of the various electronic devices involved in the implementation of the system, with the processor or processors of such devices executing the code.

In FIG. 1, the database 130 is represented twice because it performs two functions in this embodiment. The database 130 can comprise either one, two or more separate physical structures. As used herein, however, the database 130 is described as a single unit. In addition to providing the customization of the playlist 100, the database 130 also is used to gather data, intelligence and/or insight into the users that are using the system of the present invention. For example, if the system is implemented on a website for a soft drink provider, then the answer information collected by the database 130 can be used by the provider to learn about its customer base, thereby obtaining information about the website visitors' attitudes, personalities, etc. Providers can thus receive the answers 110 in a fashion that is relevant to them. In other words, while an answer 110 indicating that the user does not like tattoos may deliver a more conservative playlist 100 to the user, the same answer 110 can be delivered to the provider as “conservative.” Such data/insight can be invaluable for the provider, obtaining, with little effort, the same type of user information which otherwise may not be obtainable without time and money-consuming surveys. The present invention therefore allows the same user inputs to be useful to two different parties for two different purposes. In one embodiment of the invention, multiple providers or companies can use the same database 130 (or portions thereof), with each only having access to information from customers that accessed its particular website.

FIGS. 2-7 show various screen shots depicting the operation of the present invention from a user's perspective. All of the activities depicted in these screen shots are based upon code executed by a remote provider unit such as a server. This provider unit may include the database 130, or it may be in at least selective communication with the database 130. The process depicted in these figures can be implemented, for example, through the website of a wide variety of goods and service providers.

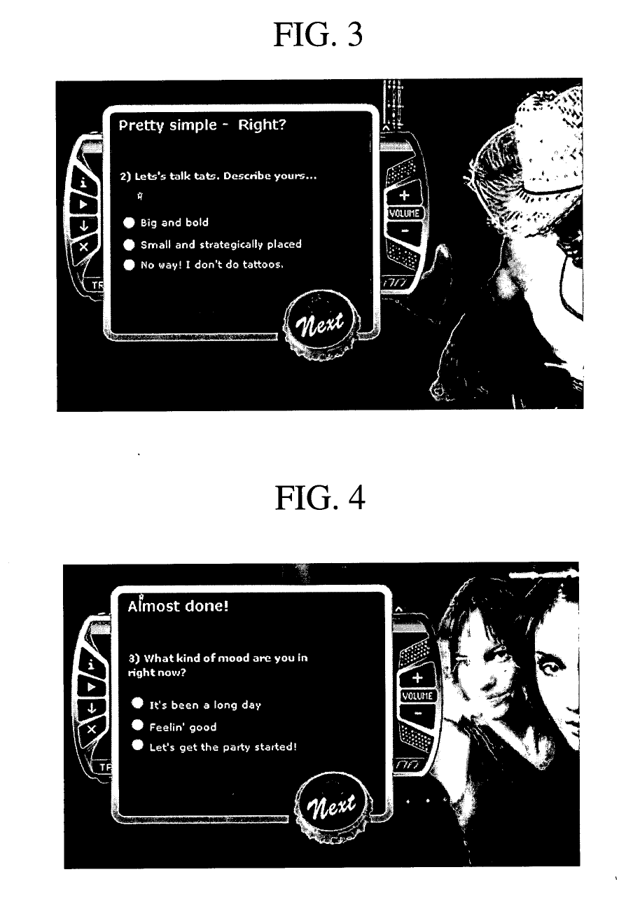

In FIG. 2, a user on his or her own computer, or similar user terminal or other electronic device, which may be in at least selective communication with the provider unit, is asked a first question 120 that correlates to a particular genre of music. In this question 120, the user is asked what type of night-time hangout he or she prefers. The three answers 110 correlate to different “styles,” and each style can correlate to a similar type of music. The questions 120 presented in FIG. 3 is more personality-oriented, asking a user about the type of tattoo he or she would prefer. Once again, the answer to this question 120 can correlate to a particular type of music. FIG. 4 shows the asking of a third question 120 which pertains directly to a user's current mood. Although only three total questions 120 are asked of the user in this particular embodiment, it is possible for more or fewer questions 120 to be asked.

Once all of the questions 120 have been asked of the user, the system of the present invention scans the database 130 and creates a playlist of media items that most closely correlate to the answers 110 provided by the user. This can be accomplished in a variety of manners. For example, FIG. 8 is a sample diagram showing how individual playlist media items are “tagged” with the answers 110 to the presented questions 120. In this example, those media items which are similar in style to the type of music played “in a laid back lounge” (option (b) in question (1)) are designated as corresponding to Answer lb. Similar tagging occurs for each media item and for each question 120. Although only nine media items are depicted in the sample diagram of FIG. 8, the database 130 could in fact possess hundreds or thousands of different playlist media items.

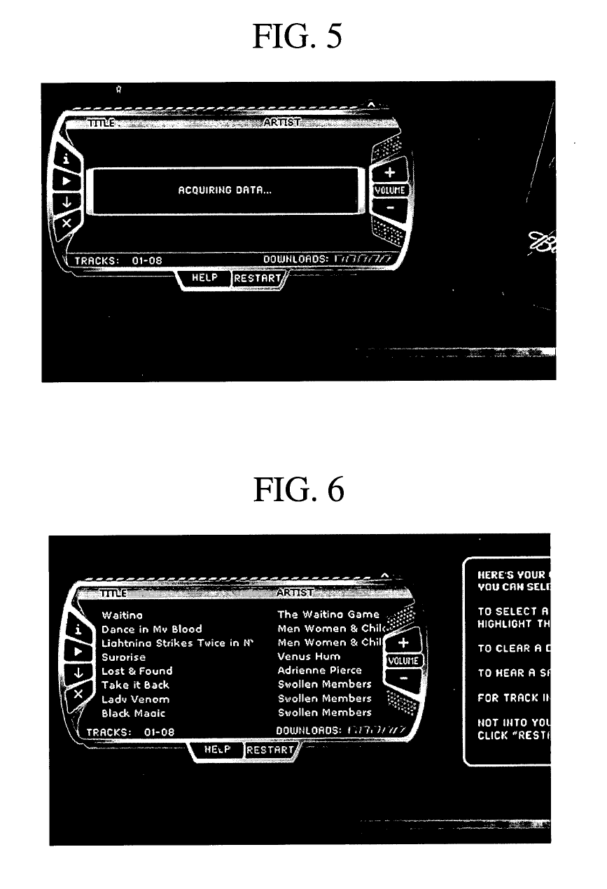

During the scanning process depicted in FIG. 5, the system checks the database 130 for those media items which closely correlate to the answers 110 provided by the user. In a database 130 with 1,000 songs, for example, this may result in the system collecting a list of every media item where all three of the “tagged” answers 110 are the same as those selected by the user. In a database 130 with fewer songs, on the other hand, it is possible that media items with fewer than a 100% correlation with the user's answers 110 may also be selected.

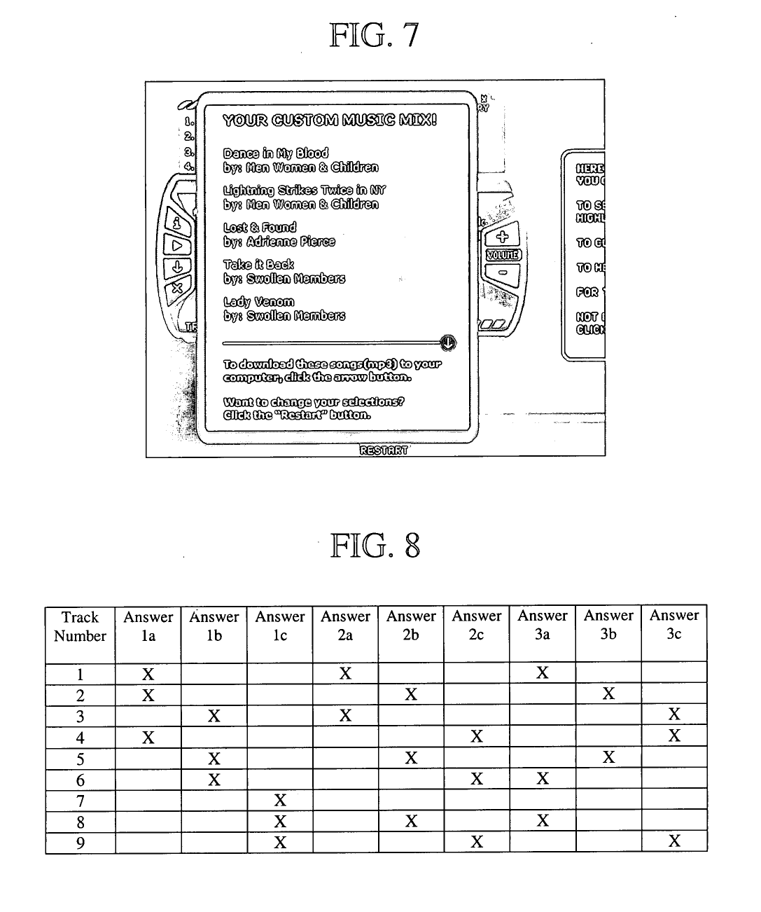

FIG. 6 is a screen shot showing the results of the scanning of the database 130. In FIG. 6, a set of media items are provided to the user that were identified by the system as correlating with the user's personality or preferences based upon the answers 110 to the given questions 120. At this point, the user is able to build his or her own playlist 100 by listening to the different playlist media items and selecting those playlist media items he or she likes. In one embodiment, a user is capable of downloading a set number of media items. Also, the system can be set up so that, if a user indicates that he or she does not like a media item, it can be replaced with another media item identified by the system as correlating to the provided answers 110. FIG. 7 is a screen shot showing a user's final playlist 100. At this point, the user is given instructions as how to download the various media items.

The present invention can be implemented in a wide variety of different ways. For example, the number of questions 120, the size of the database 130, and the size of the final playlist 100 can be varied according to the desires and/or needs of the administrator or provider. In addition, the individual media items can include information instead of or in addition to music. For example, the media items can comprise music videos, movie clips, television clips, podcasts, interviews, and syndicated content such as newspaper and magazine articles. It is also possible for non-video graphics to be included.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database 130 searching steps, correlation steps, comparison steps and decision steps. Computer code implementing the processes of the present invention can be encoded on a wide variety of computer-readable media, including, but not limited to, a computer hard drive, floppy discs, compact discs, zip drives, and carrier waves. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing a custom playlist to a user, comprising:
providing a plurality of questions to a user, the plurality of questions including at least one question relating to personality-related characteristics of the user;
receiving a plurality of answers from the user in response to the plurality of questions;
selecting a plurality of playlist media items that have been determined to correlate to the plurality of answers received from the user, the plurality of playlist media items being selected from a database including a plurality of candidate playlist media items; and
providing a list of the plurality of playlist media items to the user.

2. The method of claim 1, further comprising permitting the user to download a predetermined number of the plurality of playlist media items.

3. The method of claim 2, further comprising permitting the user to preview the playlist media items before deciding which of the plurality of playlist media items to download.

4. The method of claim 1, wherein the plurality of candidate playlist media items consist of a plurality of songs.

5. The method of claim 1, wherein the plurality of questions are provided to the user, and the plurality of answers are received from the user, through an Internet website.

6. The method of claim 5, further comprising providing information concerning the plurality of answers received from the user to a sponsor or provider of the website.

7. The method of claim 1, wherein the plurality of questions are provided to the user in conjunction with a plurality of potential answers, and wherein the plurality of answers received from the user are selected from the plurality of potential answers.

8. The method of claim 7, wherein each of the plurality of candidate playlist media items is identified as being associated with at least one of the plurality of potential answers.

9. The method of claim 8, wherein each candidate playlist media item is associated with potential answers that have been determined to potentially appeal to a particular personality-related characteristic identified with the potential answers.

10. A computer program product, embedded in a computer readable medium, for providing a custom playlist to a user, comprising:
computer code for providing a plurality of questions to a user, the plurality of questions including at least one question relating to personality-related characteristics of the user;
computer code for receiving a plurality of answers from the user in response to the plurality of questions;
computer code for selecting a plurality of playlist media items that have been determined to correlate to the plurality of answers received from the user, the plurality of playlist media items being selected from a database including a plurality of candidate playlist media items; and
computer code for providing a list of the plurality of playlist media items to the user.

11. The computer program product of claim 10, further comprising computer code for permitting the user to download a predetermined number of the plurality of playlist media items.

12. The computer program product of claim 11, further comprising computer code for permitting the user to preview the playlist media items before deciding which of the plurality of playlist media items to download.

13. The computer program product of claim 10, wherein the plurality of questions are provided to the user, and the plurality of answers are received from the user, through an Internet website.

14. The computer program product of claim 13, further comprising computer code for providing information concerning the plurality of answers received from the user to a sponsor or provider of the website.

15. The computer program product of claim 10, wherein the plurality of questions are provided to the user in conjunction with a plurality of potential answers, and wherein the plurality of answers received from the user are selected from the plurality of potential answers.

16. The computer program product of claim 15, wherein each of the plurality of candidate playlist media items is identified as being associated with at least one of the plurality of potential answers.

17. The computer program product of claim 16, wherein each candidate playlist media item is associated with potential answers that have been determined to potentially appeal to a particular personality-related characteristic identified with the potential answers.

18. A system for providing a custom playlist to a user, comprising:
a database unit including a plurality of candidate playlist media items;
a provider unit in at least selective communication with the database; and
a user terminal in at least selective communication with the provider unit,
wherein the provider unit includes:
computer code for providing a plurality of questions to a user through the user terminal, the plurality of questions including at least one question relating to personality-related characteristics of the user;
computer code for receiving a plurality of answers from the user through the user terminal in response to the plurality of questions;
computer code for selecting a plurality of playlist media items that has been determined to correlate to the plurality of answers received from the user, the plurality of playlist media items being selected from the plurality of candidate playlist media items; and
computer code for providing a list of the plurality of playlist media items to the user through the user terminal.

19. The system of claim 18, wherein the providing unit further comprising computer code for providing information concerning the plurality of answers received from the user to a sponsor or provider.

20. The system of claim 18, wherein each candidate playlist media item is associated with potential answers that have been determined to potentially appeal to a particular personality-related characteristic identified with the potential answers.

21. The system of claim 18, wherein the plurality of questions provided to the user comprise at least one question relating to a characteristic of the user selected from the group consisting of dates and locations of particular significance to the user.

22. The system of claim 18, wherein each of the plurality of questions provided to the user relate to personality-related characteristics of the user.
